(19) United States
(12) Patent Application Publication
(10) Pub. No.: US 2014/0222462 A1
(43) Pub. Date: Aug. 7, 2014

(54) System and Method for Augmenting Healthcare Provider Performance

(71) Applicants: Ian Shakil, Palo Alto, CA (US); Pelu Tran, Mountain View, CA (US)

(72) Inventors: Ian Shakil, Palo Alto, CA (US); Pelu Tran, Mountain View, CA (US)

(21) Appl. No.: 13/864,890

(22) Filed: Apr. 17, 2013

Related U.S. Application Data
(60) Provisional application No. 61/762,155, filed on Feb. 7, 2013.

(51) Int. Cl. G06Q 50/22; G06Q 10/06

(52) U.S. Cl. CPC G06Q 50/22; G06Q 10/0639
USPC 705/3

(57) ABSTRACT

A system and method for augmenting healthcare-provider performance employs a head-mounted computing device that includes camera and microphones to capture a patient encounter and events immediately before and after: video, dictation and dialog. Wearing the device by the provider during the encounter permits normal interaction between provider and patient, encouraging the provider to maintain focus on the patient. An “ears-open” earpiece delivers audio data from a remote location without obstructing the ear canal. Augmented reality multimedia is displayed via a heads-up display over the eye(s). Real-time capture of audio and video enables dramatic cost reductions by saving doctor time. Using the system, a doctor no longer need spend hours daily on transcription and EHR entry. A patient encounter is captured and transmitted to a remote station. Relevant parts of the encounter are saved or streamed, and updates to an EHR are entered for provider confirmation after the patient encounter.

### CROSS REFERENCE TO RELATED APPLICATIONS

This application claims benefit of U.S. provisional application Ser. No. 61/762,155, filed Feb. 7, 2013, the entirety of which is incorporated herein by this reference thereto.

### BACKGROUND

1. Technological Field

This disclosure generally relates to technology for enhancing real-world perception with computer-generated input. More particularly, the invention relates to a system and method for augmenting healthcare-provider performance.

2. Background Discussion

Healthcare currently represents eighteen percent of GDP (gross domestic product) of the United States and continues to expand rapidly. The healthcare enterprise in the U.S. and many other nations of the developed world is viewed generally as being massively inefficient and, thus, ripe for disruption. As the healthcare sector continues to grow, thanks to innovations in medical treatment and longer life expectancies, demands on doctors keep increasing. Unfortunately, doctor time is a scarce resource. There are fewer physicians per person in the U.S. than in any of the other 34 OECD (Organisation for Economic Cooperation and Development) countries, straining doctors to keep up with the demand for their professional opinions and time. Notably, there is a current shortage in the U.S. of 9,000 primary care doctors, with the gap predicted to worsen to 65,000 physicians within 15 years.

In the developed world, the vast majority of medical bills are paid by payers such as Medicare or private insurers (e.g. UnitedHealthcare). The current payer-provider system is here to stay for the foreseeable future. In order for insurance companies to pay for care, patients (and therefore their healthcare providers) must provide sufficient documentation to justify reimbursement. As a result, thorough documentation of the healthcare delivered is an ever-greater priority. The advent of the EHR (electronic is healthcare record) was driven in large part by the need to satisfy the ever-increasing demands of the health insurance industry and other third-party payers.

As a result of these record-keeping demands, doctors spend much of their time recording information. With the passage of the Affordable Care Act in 2010, medical records need to be compliant with a “Meaningful Use” clause of the law. The “Meaningful Use” standard specifies certain performance objectives that EHRs must satisfy in order to meet the standard, for example:
An EHR must be male to record the smoking status of all patients older than thirteen; and
Must provide clinical summaries for patients for each office visit, and so on.

Thus, the recordkeeping requirements imposed by the “meaningful use” standard only multiply the amount of time providers must already spend inputting healthcare data.

Providers lament this shift. They sense that the humanity of the doctor-patient relationship is being eroded. Providers also recognize that their bedside manner is suffering and that they are unable to connect with patients as they have in the past. “Excuse me if, like a teenager transfixed by her smartphone, my eyes are glued to my screen at your next visit with me. I am truly listening to you. It's just that eye contact has no place in the Land of Meaningful Use,” one doctor wrote recently in an article in a major national newspaper.

There are also important economic consequences of the requirement to capture such massive amounts of data. Providers find that they are able to see fewer patients every day as a result of the requirements posed by electronic health records, further straining the already-limited resource of provider time. The financial climate for the medical profession is rapidly deteriorating: revenues are under pressure as a result of declining reimbursement rates; expenses are rising due to the myriad costs involved in providing services; and malpractice insurance rates just become more onerous. Providers therefore feel a desperate need to explore every possible avenue to bring their fiscal situation into order.

There may be a light at the end of the tunnel. The Affordable Care Act is catalyzing the formation of new healthcare systems oriented around ACOs (accountable care organizations). In an ACO system, providers are incentivized to provide care that improves patients' health in measurable ways instead of documenting visits just for the sake of documentation. However, it may take decades for this new healthcare delivery model to take hold.

Even in an ACO world, the need for substantial notes will not disappear, as medicine becomes increasingly data-driven and as providers are increasingly incentivized to become collaborative actors in a larger care team. The nature of records is expected to change from a focus on reimbursement to being able to capture and share medically-relevant information. Thus, the note-taking burden may not be reduced and may even continue to increase.

### SUMMARY

A system and method for augmenting healthcare-provider performance employs a head-mounted computing device that includes camera and microphones to capture a patient encounter and events immediately before and after: video, dictation and dialog. Wearing the device by the provider during the encounter permits normal interaction between provider and patient, encouraging the provider to maintain focus on the patient. An “ears-open” earpiece delivers audio data from a remote location without obstructing the ear canal. Augmented reality multimedia is displayed via a heads-up display over the eye(s). Real-time capture of audio and video enables dramatic cost reductions by saving doctor time. Using the system, a doctor no longer need spend hours daily on transcription and EHR entry. A patient encounter is captured and transmitted to a remote station. Relevant parts of the encounter are saved or streamed, and updates to an EHR are entered for provider confirmation after the patient encounter.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 provides a diagram of an embodiment of a system for augmenting performance of healthcare providers;

FIG. 2 provides a diagram of an additional embodiment of a system for augmenting performance of healthcare providers;

FIG. 3 provides a diagram of a further embodiment of a system for augmenting performance of healthcare providers;

FIG. 4 provides a block diagram of a computational infrastructure underlying any of the embodiments of FIGS. 1-3;

FIG. 5 provides a diagram of a back end from the system of FIGS. 1-3

FIGS. 6-8 provide assorted views of a mobile provider interface from the system of FIG. 1-3;

FIGS. 9-11 provide exemplary screen shots from a user interface to the mobile provider interface of FIGS. 6-8.

FIG. 12 is a block diagram of a computer system suitable for implementing a system for augmenting healthcare provider performance according to certain embodiments.

### DESCRIPTION

A system and method for augmenting healthcare-provider performance employs a head-mounted computing device that includes camera and microphones to capture a patient encounter and events immediately before and after: video, dictation and dialog. Wearing the device by the provider during the encounter permits normal interaction between provider and patient, encouraging the provider to maintain focus on the patient. An ears-open′ delivers audio data from a remote location without obstructing the ear canal. Augmented reality multimedia is displayed via a heads-up display over the eye(s). Real-time capture of audio and video enables dramatic cost reductions by saving doctor time. Using the system, a doctor no longer need spend hours daily on transcription and EHR entry. A patient encounter is captured and transmitted to a remote station. Relevant parts of the encounter are saved or streamed, and updates to an EHR are entered for provider confirmation after the patient encounter.

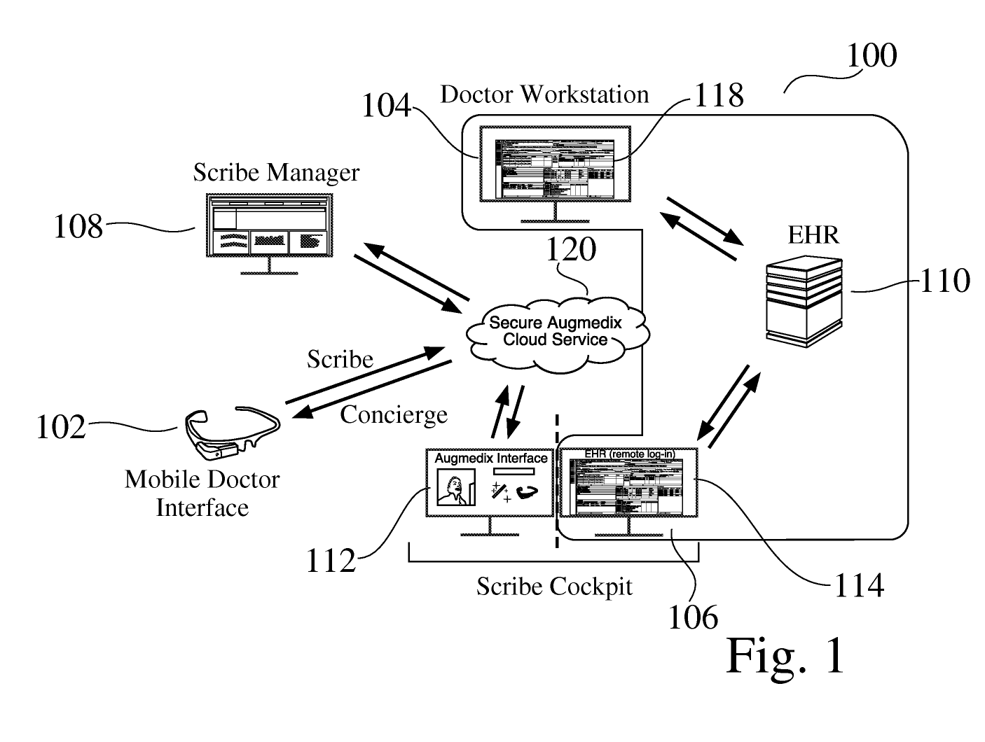

Turning now to FIG. 1, shown is an architecture diagram of an embodiment of a system 100 for augmenting healthcare provider performance. As shown in FIG. 1, the system 100 includes a plurality of interfaces, each communicatively coupled to each other via a secure cloud-based service 120. In one embodiment, the system comprises four interfaces:
a mobile provider interface 102;
a provider work station 104;
a Scribe cockpit 106; and
a Scribe manager 108.

Additionally, as in FIG. 1, the architecture also includes an EHR 110 communicatively coupled to, in its turn, to the provider workstation 104 and the scribe cockpit 106.

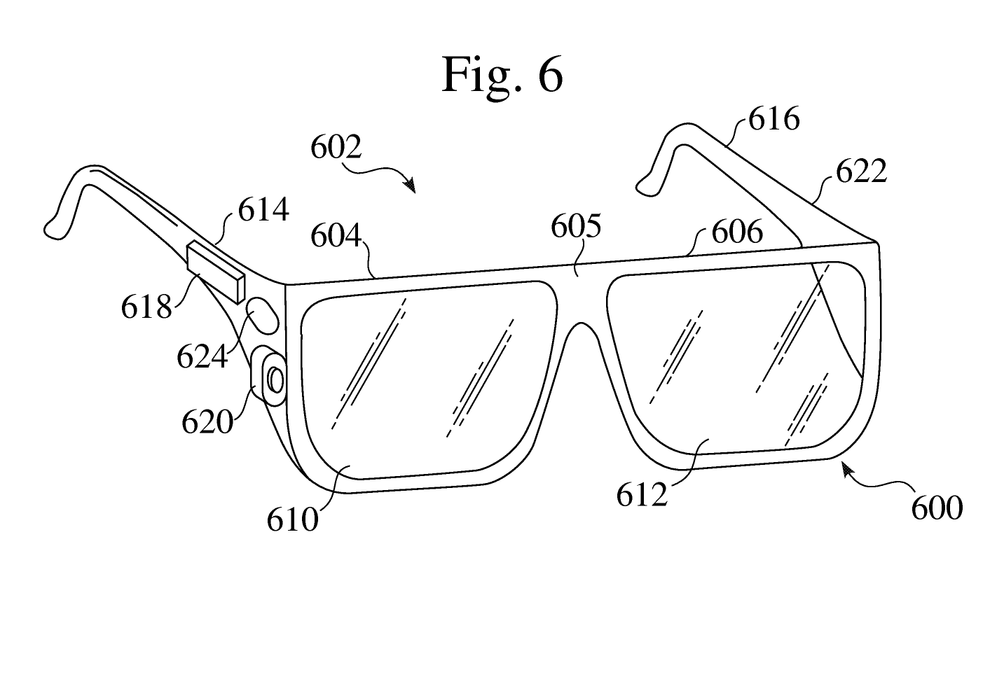

In an embodiment, the mobile provider interface 102 may reside on a wearable head-mounted computing device 600 such as those shown in FIGS. 6-8. In various embodiments, the computing device 600 may be, for example, the VUZIX M100, GOOGLE GLASS or LOOXCIE (LOOXCIE, Inc., Sunnyvale, Calif.) or any other similar head-mounted display device or wearable augmented reality device. Typically, the device is worn by a provider during a patient encounter. The provider interface 102 is presented to the provider and viewable by the provider as the provider interacts with the patient during the patient encounter. Typically, the patient encounter is an interactive session wherein the provider is examining the patient in a clinic setting or in the examining room of an office or other healthcare facility and eliciting information from the patient by questioning the patient. The environment of use however is not meant to be is limiting and may also include an encounter in a hospital emergency room, or in an operating suite wherein the patient is present but unconscious. Additionally, the encounter may occur, for example, at the scene of an accident, at the scene of a mass casualty or even under battlefield conditions.

It is to be appreciated that the expression “provider” may denote a physician. However, the provider may, in fact, be almost any healthcare worker who is interacting with the patient during the patient encounter. Thus, a provider could easily be a nurse or a nurse practitioner, a physician's assistant, a paramedic or even a combat medic, or any other healthcare worker involved in the delivery of treatment and care to the patient during the patient encounter.

Additionally, although the foregoing description assumes that a single provider is wearing the computing device 600, in additional embodiments, other members of the healthcare team may be present during the patient encounter and each may be equipped with a wearable computing device 600 over which the provider interface 102 may be accessed.

In an embodiment, the device 600 may include, as described herein below, at least one microphone and at least one video camera. Embodiments may also include one or more sensors for multi-channel video, 3D video, eye-tracking, air temperature, body temperature, air pressure, skin hydration, exposure to radiation, heart rate, and/or blood pressure. Embodiments may include one or more accelerometers, gyroscopes, compasses, and/or system clocks. Embodiments may include at least one projector/display. Embodiments may include circuitry for one or both of wireless communication and geo-location. Embodiments may include an open-canal earpiece for delivery of remotely-transmitted audio data to the provider. Among the features of the provider interface 102 features that allow the provider to summon and receive information from the EHR 110, mediated by a remote Scribe. As described herein below, the Scribe may be a human scribe. In other embodiments, the Scribe is a virtual scribe, the virtual scribe constituting one or more interactive software modules executing on a remote computing device. In addition to retrieving information, the provider, via the provider interface 102 is able to transmit data generated and captured during the patient encounter for documentation purposes as described farther below. Additionally, the computing device captures ambient sound in the immediate vicinity of the patient encounter. Ambient sound may include conversation between the provider and a patient or among various members of a healthcare team that may be present during the patient encounter.

Furthermore, it is to be appreciated that the expression ‘remote’ in application to the Scribe, simply means that the Scribe is not located in the immediate vicinity of the patient encounter. In various embodiments, the Scribe may be physically located in the same healthcare facility in which the patient encounter is taking place, or the Scribe may be located, for example, in a facility that is on the other side of the world from the location of the patient encounter and any point there between.

### The Provider Workstation 104

At some point after the patient encounter, the provider may review the documentation created by the remote scribe. It is the provider workstation 104 that facilitates this review. It will be understood that the distinguishing feature of the workstation is a user interface 118 that allows the provider to review the content generated by the Scribe. In an embodiment, the user interface 118 is created and implemented by the vendor or the manufacturer of an EHR management software application and provides the capability for non-medical or medical personnel to write documentation from data generated and captured during and as a result of a patient encounter. Typically such software applications provide a ‘pending’ feature, wherein the documentation created by the Scribe does not become a permanent part of the patient's EHR unless and until the pending content is reviewed by the provider and confirmed. Additionally, the user interface 118 provides the provider the capability to edit the pending content generated by the Scribe.

In other embodiments, the user interface 118 is a product of the provider of the system 100 and may be autonomous from the EHR, while synchronizing with the EHR data via one or more APIs (application programming interface) and one or more standards such as HL7 (HEALTH LEVEL 7 INTERNATIONAL,) that define the format for transmission of health-related information.

It is to be appreciated that, in practice, the provider workstation 104 can be any computing device which can be communicatively coupled with the system 100, is capable of displaying the user interface 118 and which allows the provider to review, edit and confirm the generated documentation. Such devices may include desktop, laptop or tablet computers, or mobile devices such as smartphones. In an embodiment, the provider review may occur via the provider interface. The coupling of the provider workstation 104 with the remainder of the system may be via wired or wireless connection.

The Scribe Cockpit 106

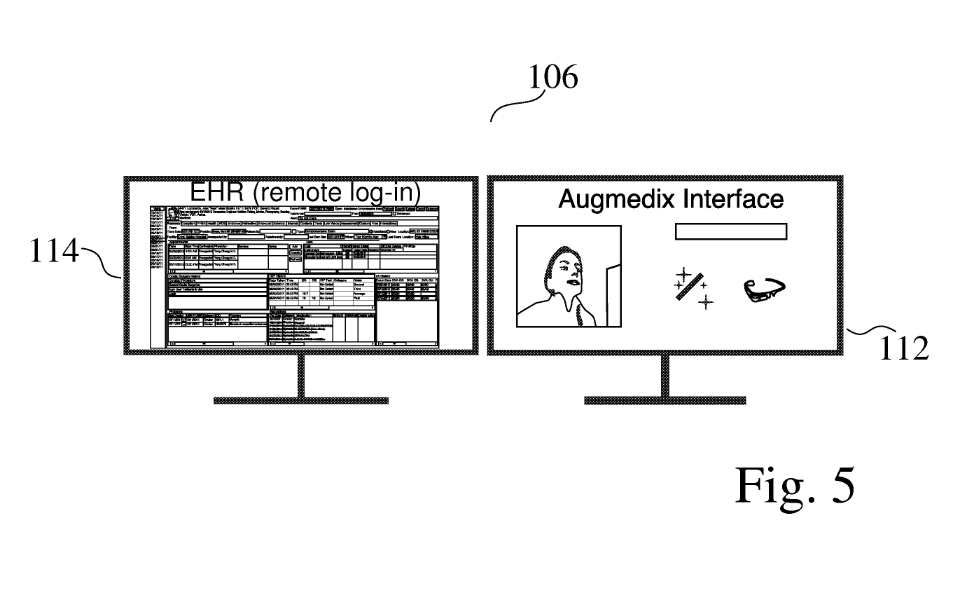

In an embodiment, the scribe cockpit (also shown in FIG. 5) may combine two sub interfaces the EHR interface 114 and a system interface 112. In recognition of the highly-confidential nature of healthcare data, an embodiment may include a multi-level authentication protocol that requests secure authentication by the scribe on the system 112 and on the EHR 114.

The EHR Interface 114

In an embodiment, the EHR interface 114 may be a remote log-in version of the EHR being used by the provider, which in various embodiments may be, for example EPIC (EPIC SYSTEMS CORPORATION, Madison, Wis.) or NEXTGEN (NEXTGEN HEALTHCARE INFORMATION SYSTEMS, Horsham, Pa.) or any number of other generally-available EHR systems. When a Scribe enters notes on behalf of the provider, he/she keys the data directly into the EHR interface 114 from his/her computer. Similarly, when the doctor queries information via Concierge (e.g. “give me the White Blood Cell count”), the scribe may scout out this information by navigating the EHR interface.

The System Interface 112

The second interface contained within the Scribe Cockpit a system interface 11 providing at least the functions of:
Showing audio and visual streams from provider-patient interactions;
Allowing for archive access, FF (fast forward), RW (rewind), high-speed playback, and a number of other features as described in greater detail herein below;
Allowing the scribe to communicate back to the doctor in response queries for data. For example,
   Typing and sending back quick answers to the provider;
   Using a magic wand tool to select graphics, tables, and text cropped screenshots from the EHR interface and to send back to the provider;
   Assisting the provider in diagnosing the conditions, prescribing treatments or medication; and
   Sending textual or graphical data from journal articles, clinical studies, treatment guidelines, equipment instructions, procedure checklists, drug information, or any other relevant medical or technical data to the provider.

### Scribe Manager 108

Referring again to FIG. 1, a Scribe Manager provides lightweight administrator web-based interface system management. It allows the system administrator to review and manage supply, demand, outages, routing, auditing, performance reviews, permission granting, permission removals, schedules and other administrative tasks common to the management of large distributed systems such as herein described. The admin can also audit ongoing communications between doctors and scribes using Augmedix as well as archived media.

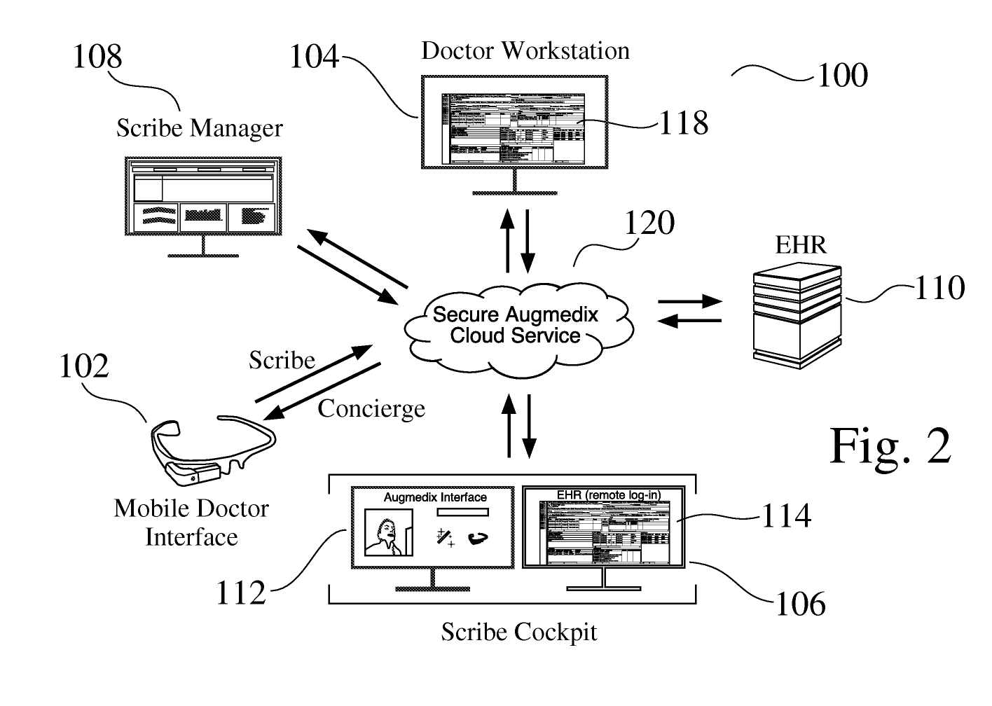

Turning now to FIG. 2, shown is an architecture diagram of a further embodiment of a system 100 for augmenting performance of a healthcare provider. The present embodiment provides an architecture wherein EHR 110 connectivity is achieved through direct APIs and/or HL7 standards.

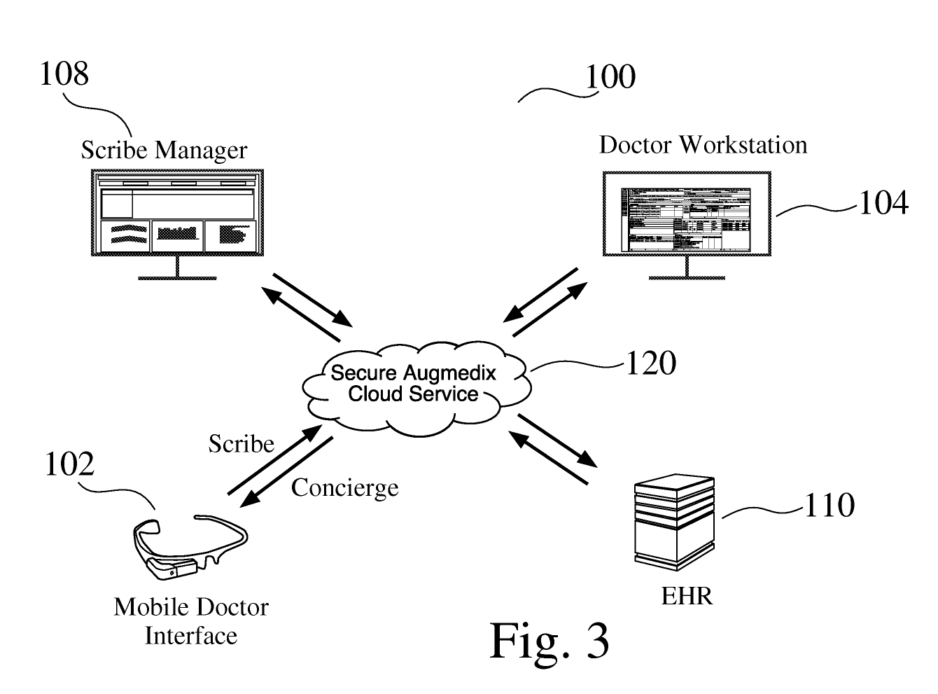

Referring now to FIG. 3, shown is an architecture diagram of a still further embodiment of a system 100 for augmenting performance of a healthcare provider wherein the Scribe function is fully virtualized, therefore eliminating any need for the Scribe cockpit 106.

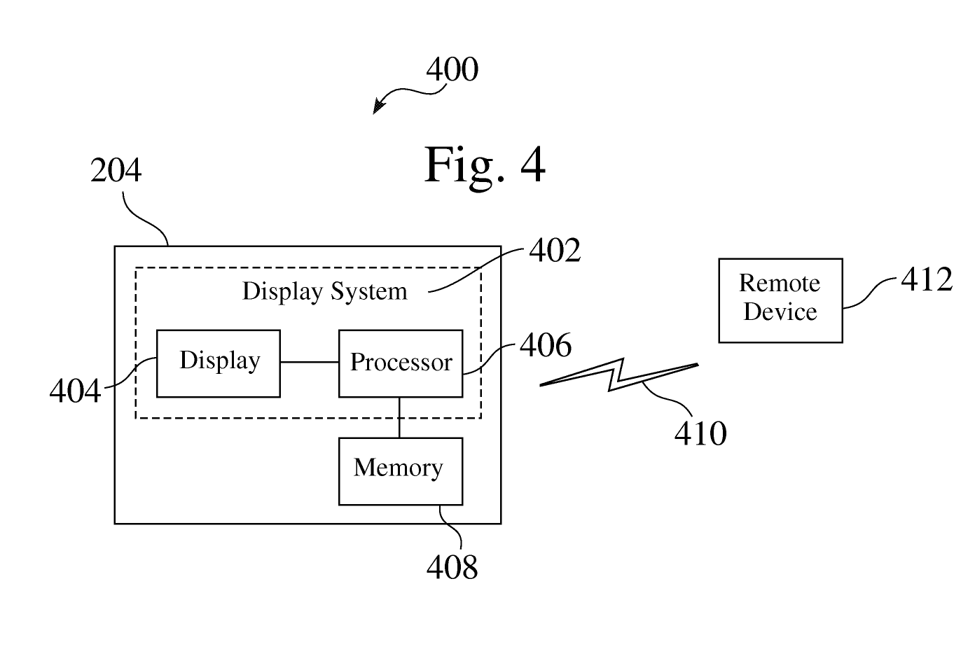

FIG. 4 illustrates a schematic drawing of an example computing network 400 upon which the system 100 may be implemented. In system 400, a device 204 communicates using a communication link 410 (e.g., a wired or wireless connection) to a remote device 412. The device 204 may be any type of device that can receive data and display information corresponding to or associated with the data. For example, the device 204 may be a heads-up display system, such as a head-mounted device 600 as shown in FIGS. 6-8.

Thus, the device 204 may include a display system 402 comprising a processor 406 and a display 404. The display 404 may be, for example, an optical see-through display, an optical see-around display, or a video see-through display. The processor 406 may receive data from the remote device 412, and configure the data for display on the display 404. The processor 404 may be any type of processor, such as a micro-processor or a digital sign processor, for example.

The device 404 may further include on-board data storage, such as memory 408 coupled to the processor 406. The memory 408 may store software that can be accessed and executed, by the processor 406, for example.

The remote device 412 may be any type of computing device or trans fitter including a laptop computer, a mobile telephone, tablet computing device, or server, etc., that is configured to transmit data to the device 404. The remote device 412 and the device 404 may contain hardware to enable the communication link 410, such as processors, transmitters, receivers, antennas, etc. Additionally, the remote device may constitute a plurality of servers over which one or more components of the system 100 may be implemented.

In FIG. 4, the communication link 410 is illustrated as a wireless connection; however, wired connections may also be used. For example, the communication link 410 may be a wired serial bus such as a universal serial bus or a parallel bus. A wired connection may be a proprietary connection as well. The communication link 410 may also be a wireless connection using, e.g., BLUETOOTH radio technology, communication protocols described in IEEE 802.11 (including any IEEE 802.11 revisions), Cellular technology (such as GSM (Global System for Mobile Communications), COMA (Code Division Multiple Access), UMTS (Universal Mobile Communications System), EVDO (EVolution Data Optimized), WiMAX. (Worldwide Interoperability for Microwave Access), or LTE (Long-Term Evolution)), NFC (Near Field Communication), or ZIGBEE (IEEE 802.15.4) technology, among other possibilities. The remote device 410 may be accessible via the Internet and may include a computing cluster associated with a particular web service (e.g., social-networking, photo sharing, address book, etc.).

FIG. 5 provides an expanded view of the scribe cockpit 106, fully described herein above in relation to FIG. 1

FIG. 6 illustrates an example system 600 for receiving, transmitting, and displaying data. The system 600 is shown in the form of a head-wearable computing device. Examples of such computing devices are different forms of augmented-reality eyewear such as VUZIX SMART GLASSES (VUZIX CORPORATION, Rochester, N.Y.), GOOGLE GLASS (GOGGLE CORPORATION, Mountain View Calif.) or LOOXCIE (LOOXCIE, Inc., Sunnyvale, Calif.).

While FIG. 6 illustrates a head-mounted device 602 as an example of a wearable computing device, other types of wearable computing devices could additionally or alternatively be used, such as Augmented Reality Contact Lenses (INNOVEGA, INC., Bellevue, Wash.). Additionally, gestural augmented reality interfaces such as SIXTHSENSE (MIT MEDIA LAB, Massachusetts Institute of Technology, Cambridge, Mass.) or various wearable aural augmented reality interfaces may form part or all of the interface in various embodiments.

As illustrated in FIG. 6, an embodiment of a head-mounted device 602 may be composed of a plurality ref frame elements including one or more of:
one or more lens-frames 604, 606;
a center frame support 608;
one or more lens elements 610, 612; and
extending side-arms 614, 616.

In an embodiment, the center frame support 608 and the extending side-arms 614, 616 may be configured to secure the head-mounted device 602 to a user's face via the user's nose and ears.

Each of the frame elements 604, 606, and 608 and the extending side-arms 614, 616 may constitute either a solid structure of plastic and/or metal, or a hollow structure of similar material so as to allow wiring and component interconnects to be internally routed through the head-mounted device 602. Other embodiments may be fabricated from other materials having one or more of the characteristics of durability, light weight and manufacturability.

Each lens element 610, 612 may be formed of any material that can suitably display a projected image or graphic, in an embodiment, the lenses may be fabricated from polycarbonate. In additional embodiments, the lenses may be fabricated from CR-39 or TRIVEX (both from PPG INDUSTRIES, inc., Pittsburgh, Pa.) or other similar materials providing the desired optical characteristics and wear-ability profile. Each lens element 610, 612 may also be sufficiently transparent to allow a user to see through the lens element. Combining these two features of the lens elements may facilitate an augmented reality or heads-up display where a projected image or graphic is superimposed over a real-world view as perceived by the user through the lens elements.

The extending side-arms 614, 616 may each be projections that extend away from the lens-frames 604, 606, respectively, and may be positioned behind a user's ears to secure the head-mounted device 602 to the user. The extending side-arms 614, 616 may further secure the head-mounted device 602 to the user by extending around a rear portion of the user's head, Additionally or alternatively, for example, the system 600 may connect to or be affixed within a head-mounted helmet structure. Other possibilities exist as well. An embodiment includes at least one open-ear earpiece integrated with, for example, one or both of the extending side arms 614, 616. In one embodiment, the open-ear earpiece may be a bone-conduction earpiece. The bone-conduction earpiece minimizes the possibility that data transmitted to the provider will be overheard by others, Additionally, the bone-conduction earpiece keeps the providers ear canal open.

The system 600 may Iso include an on-board computing system 618, a video camera 120, a sensor 622, and a finger-operable touch pad 624. The on-board computing system 618 is shown to be positioned on the extending side-arm 614 of the head-mounted device 602. In one or more other embodiments, the on-board computing system 618 may be provided on other parts of the head-mounted device 602 or may be positioned remote from the head-mounted device 602. For example, the on-board computing system 618 could be wire- or wirelessly-connected to the head-mounted device 602). The on-board computing system 618 may include a processor and memory, for example. The on-board computing system 618 may be configured to receive and analyze data from the video camera 620 and the finger-operable touch pad 624 (and possibly from other sensor/devices, user interfaces, or both) and generate images for output by the lens elements 610 and 612.

The video camera 620 is shown positioned on the extending side-arm 614 of the head-mounted device 602. In other embodiments, the video camera 620 may be provided on other parts of the head-mounted device 602. The video camera 620 may be configured to capture images at various resolutions or at different frame rates. Many video cameras having a small form-factor, such as those used in cell phones or webcams, for example, may be incorporated into separate embodiments of the system 600.

Further, although FIG. 6 illustrates a single video camera 620, additional video cameras may be used, Each may be configured to capture the same view, or to capture different views. For example, the video camera 620 may be forward facing to capture at least a portion of the real-world view perceived by the user. This forward-facing image captured by the video camera 620 may then be used to generate an augmented reality where computer generated images appear to interact with the real-world view perceived by the user.

Although the sensor 622 is shown on the extending side-arm 616 of the head-mounted device 602, in additional embodiments, however, the sensor 623 may be positioned on other parts of the head-mounted device 602. The sensor 622 may include one or more of a gyroscope, an accelerometer, and a compass, for example. Other sensing devices may be included within, or in addition to, the sensor 622 or other sensing functions may be performed by the sensor 622.

The finger-operable touch pad 624 is shown on the extending side-arm 614 of the head-mounted device 602. However, the finger-operable touch pad 624 may be positioned on other parts of the head-mounted device 602. Also, more than one finger-operable touch pad may be present on the head-mounted device 602. The finger-operable touch pad 624 may be used by a user to input commands. The finger-operable touch pad 624 may sense at least one of a position and a movement of a finger via capacitive sensing, resistance sensing, or a surface acoustic wave process, among other possibilities, The finger-operable touch pad 624 may be capable of sensing finger movement in a direction parallel or planar to the pad surface, in a direction normal to the pad surface, or both, and may also be capable of sensing a level of pressure applied to the pad surface. The finger-operable touch pad 624 may be formed of one or more translucent or transparent insulating layers and one or more translucent or transparent conducting layers. Edges of the finger-operable touch pad 624 may be formed to have a raised, indented, or roughened surface, so as to provide tactile feedback to a user when the user's finger reaches the edge, or other area, of the finger-operable touch pad 624. If more than one finger-operable touch pad is present, each finger-operable touch pad may be operated independently, and may provide a different function.

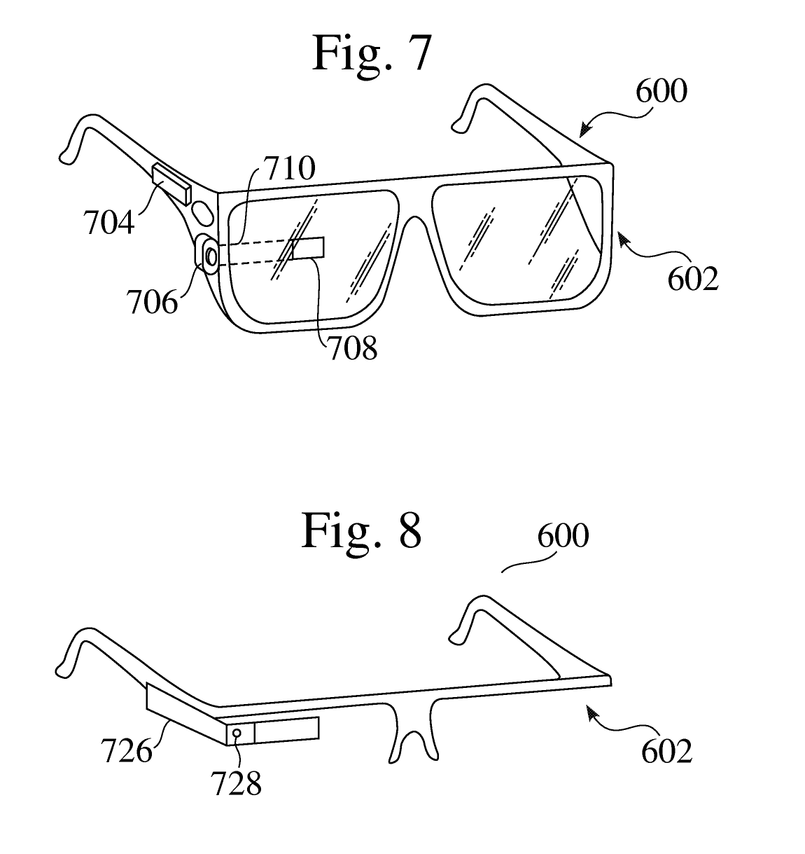

FIG. 7 illustrates a further embodiment of the system 600, in the form of a wearable computing device 602. The wearable computing device 602 may include frame elements and side-arms such as those described with respect to FIG. 6. The wearable computing device 602 may additionally include an on-board computing system 704 and a video camera 706, such as those described with respect to FIG. 6. The video camera 706 is shown mounted on a frame of the wearable computing device 602; however, the video camera 706 may be mounted at other positions as well.

As shown in FIG. 7, the wearable computing device 602 may include a single display 708 which may be coupled to the device. The display 708 may be formed on one of the lens elements of the wearable computing device 602, such as a lens element described with respect to FIG. 6, and may be configured to overlay computer-generated graphics in the user's view of the physical world. The display 708 is shown to be provided in a center of a lens of the wearable computing device 602; however, the display 708 may be provided in other positions. The display 708 is controllable via the computing system 704 that is coupled to the display 708 via an optical waveguide 710.

In a further embodiment, as shown in FIG. 8, the wearable computing device 602 does not include lens-frames containing lens elements. The wearable computing device 602 may additionally include an onboard computing system 726 and a video camera 728, such as those described with respect FIGS. 6 and 7.

### Scribe Software Feature

As a provider and patient are having an interview, the Scribe software feature pipes the audio-visual stream, from the doctor's perspective, to a 3^{rd} party at a remote location. The expression “3^{rd} party” within the present context may refer to a number of different entities. In an embodiment, the 3^{rd} party may be a human Scribe at a remote location. As above, a remote location means only that the human scribe is not within the immediate vicinity of the patient encounter. In actual fact, the Scribe could be stationed within the same healthcare facility or he/she could be stationed half a world away.

In an embodiment, a 3^{rd} party may be a virtual scribe composed of one or more software elements, components or modules executing on a remotely-located computing device. In an embodiment, the software may include one of both of NLP (natural language processing) and speech recognition software that processes the spoken portion of the transmission from the interview to textual data for entry, in whole, or in part, into the EHR and for eventual archiving. In an embodiment, a 3^{rd} party may be a remote consultant or instructor invited to participate in the interview to provide a 2^{nd} opinion to the patient and the provider, or to instruct the provider who may be a trainee needing supervision or guidance in the proper assessment and/or treatment of the patient.

In an embodiment, the 3^{rd} party may be a student or group of students who have been authorized to witness the interview as an instructional experience.

In an embodiment, the 3^{rd} party may be a family member, a guardian or a legal representative or a member of the judiciary witnessing the encounter in order to assess the patient's competence, for example.

In an embodiment, the 3^{rd} party may be a consulting physician or care provider also providing care to the patient.

Additionally, there may be more than one 3^{rd} party.

In the case that the 3^{rd} party is a remotely-stationed human scribe, he/she completes the note and documentation, in real time, on behalf of the provider. Importantly, the remote scribe manages the routine EHR elements (dropdowns, forms, templates, etc.) so that the provider's entire focus may remain with the patient. At the end of the day, or at the end of the interview, when the provider turns his/her attention to the computer, all he/she need do is click ‘confirm’ in the EHR software, and perhaps make minor edits.

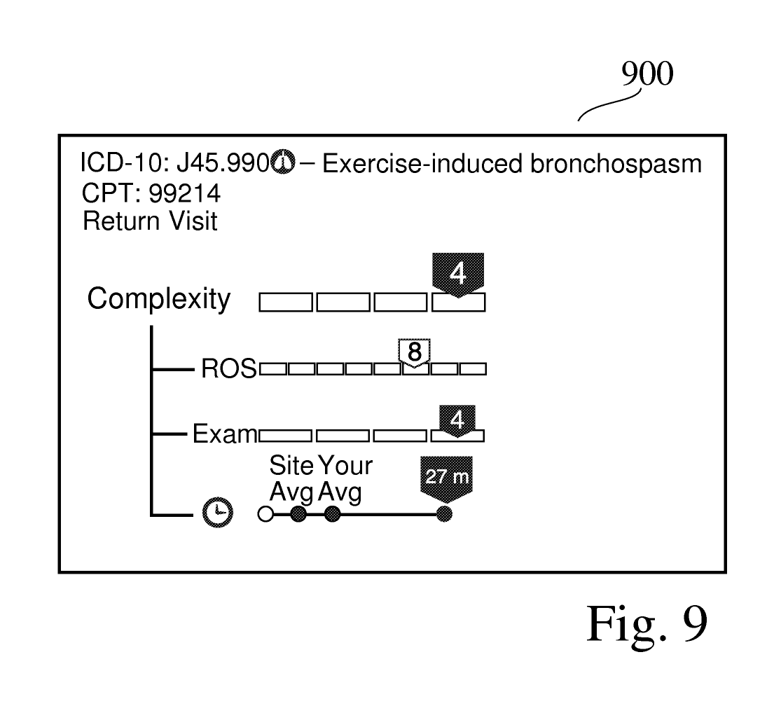

FIG. 9 provides an example screen shot of a record 900 presented to the doctor via the display in computing device 602 at the end of a scribing session. The patient presented with a complaint of shortness of breath. The record supplies the correct diagnosis, diagnostic codes and procedure codes. Additionally, the record provides a summary of the findings: complexity, ROS (review of systems) and the extent of the physical exam. Additionally, the record displays the amount of time spent with the patient and compares the time spent with the average for the provider and for the facility. The foregoing description is provided only as an illustration and is not limiting.

### Concierge Software Feature

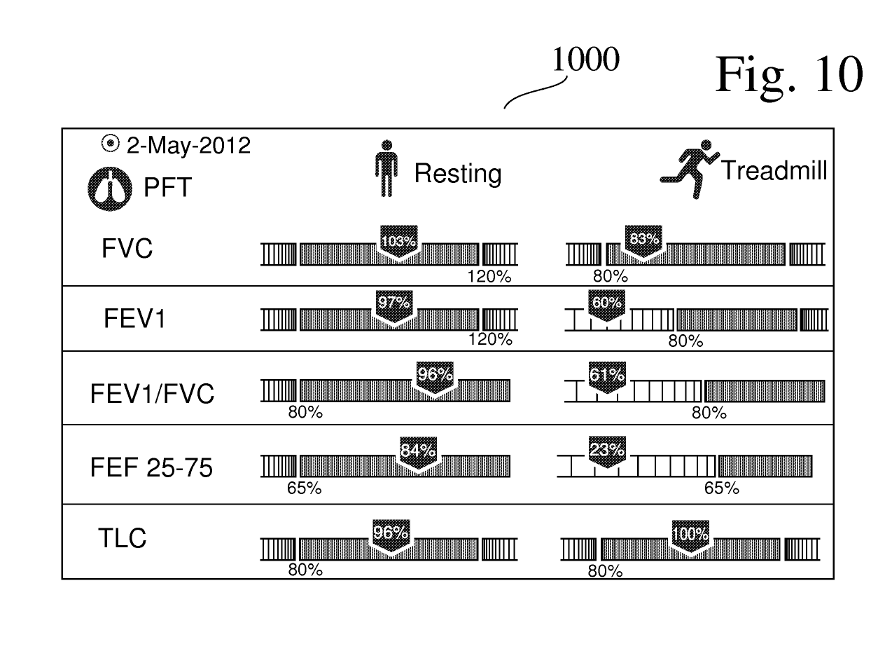

The Concierge feature is the opposite of the Scribe feature. With the Concierge feature, a provider can verbally summon information (e.g. white blood cell count, CXR results) and have the results seamlessly delivered to the interface of his/her mobile device 602. For example, FIG. 10 shows a screen shot of a pulmonary function test (PFT) results 1000 displayed for the provider in response to the provider's request. In this example, data from the electronic medical record is used. Other sources of clinical decision support, for example external resources such as PUBMED or UPTODATE, may be accessed by the physician as well.

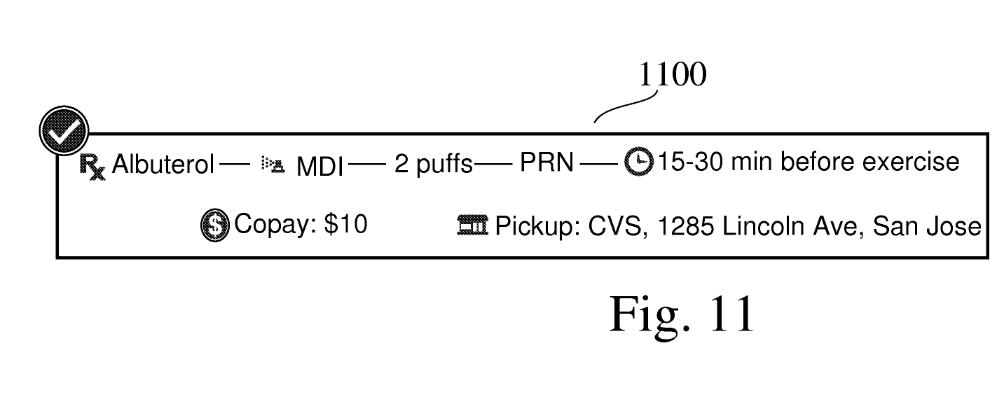

Additionally, the Concierge feature also offers providers the ability to place prescriptions and dictate orders. FIG. 11 provides a screen shot of a confirmation of a prescription order 1100 directed to the Scribe by the provider.

### Security

Stringent security provisions are designed into the system. For example:
Regular checks that regulatory and legislative compliance requirements are met;
Security awareness training provided to all staff
Account lock-out: If a user incorrectly authenticates 5 times, their user account will be locked
Encryption over-the-wire (“in-transit”) as well as in backend systems (“at-rest”)
   Strongest encryption level supported on the internet today (SSL—256 bits)
   Any audiovisual data stored is split into pieces and then each piece is encrypted with a separate key
Full audit trail (past 12 months)
Servers are hosted in highly secure environment with administrative access given to not more than 2 senior employees. Security checks include:
   24/7 physical security;
   On-going vulnerability checks;
   Daily testing by anti-malware software such as MCAFEE SECURED for known vulnerabilities; and
   Adopted best practices such as Defense in Depth, Least-Privilege and Role Based Access Control

As in the foregoing description, the system software provides the fundamental capabilities of Scribe and Concierge. A large number of advanced features flow directly from the fundamental capabilities of the system. Certain embodiments may contain all of the features listed below in Table 1. Other embodiments may contain one or more features selected from Table 1, below.

TABLE 1

| Name | Detailed Description |
|---|---|
| Secure log in | Doc verbally states passcode to sign-on. Or doc looks at QR code on badge. Or |
| | some alternative. |
| Ultra secure log in | Doc verbally states passcode to sign-on, voice recognition software provides |
| | additional authentication redundancy a Ia |
| | http://www.phonearena.com/news/Voice-Unlock-debuts-with-the-Lenovo- |
| | A586_id37216. Also can use other modes of recognition, including connectivity to |
| | workstation on which the physician has previously logged into. |
| Ultra secure auto | Glasses “sign off” if accelerometer indicates no movement for X minutes and/or if |
| log-off | glasses geo-locate to an offsite location or if other unusual patterns occur |
| Standard log off | Log off should automatically occur as the doctor exits a room when a patient is |
| | present, by default. It can be automatically triggered via patient recognition, geo- |
| | location, physician voice, BLUETOOTH/wireless triggering on entering the room, |
| | or environmental image recognition. |
| Patient recognition/ | Glasses geo-locate/sync up with EHR scheduling data. When doc enters the |
| geo-location | room, the following data are shown |
| | Name |
| | Portrait: picture |
| | Medical record number |
| | Chief complaint |
| | Medically relevant data including but not limited to previous and current |
| | diagnoses, previous and current medications, demographic information, code |
| | status, or patient preferences. |
| | Patient recognition can occur through Wi-Fi/Bluetooth geo-location/QR codes/ |
| | facial recognition. |
| | Doc needs ability to inform scribe if an exception occurs. |
| “record indicator” for | An alert, either audio, visual, or some combination of the two, comes up that |
| EHR Push | indicates that |
| | The system is working/live |
| | A remote scribe is listening/watching |
| | This indicator/status should automatically appear as the doctor enters a room |
| | when a patient is present, by default. It can be automatically triggered via patient |
| | recognition, geo-location, physician voice, Bluetooth/wireless triggering on |
| | entering the room, or environmental image recognition. |
| Incognito mode | Doc has ability to speak, swipe, click button, or gesture - which informs glass to |
| | not record. This can be for legal, patient privacy, or personal preference. |
| “record to | Icon briefly appears, and then fades away. Indicates that |
| remember” | The system is working/live |
| | A remote scribe is listening/watching |
| | The remote scribe will email this particular portion of the interview to the patient |
| | (audio only). |
| | The patient will receive an email link, allowing him to view this audio snippet. |
| | The doc should have the ability to review/reject/edit this audio-to-be-sent-to- |
| | patient during workstation confirmation |
| Summary | Summary data appears for doctor, after interview is over. The remote scribe has |
| Dashboard | discretion to indicate to the system when the interview is over. Once the interview |
| | is over, the following information is presented: |
| | Patient name |
| | Patient picture |
| | Medical record number |
| | Current and newly prescribed medications |
| | Placed orders (e.g. tests) |
| | Total duration of interview |
| | Encounter reimbursement score |
| | (this score will be determined automatically or by remote scribe, by listening in to |
| | conversation, and scoring on whether certain types of questions, diagnoses, etc. |
| | took place) |
| Ordering via | Doctor interfaces with portable hands free device such as Google glass, either |
| Remote Scribe | verbally (by saying a predetermined phrase such as “Augmedix order”) or by |
| | swipe and click interface with the display. |
| | Either a visual (e.g. popup or flash on display) or audio (e.g. chime sounding) |
| | confirms reception. |
| | Ordering process can be done via a combination of verbal and physical |
| | swipe/click interface. Each additional piece of data inputted (e.g. the name of the |
| | medication) automatically triggers display of the next decision point in the ordering |
| | process (e.g., oral vs. IV delivery route or available dosages). |
| | The final order is sent to the EMR or other order processing system to be |
| | prescribed. |
| | Dashboard is displayed showing: |
| | Drug was committed to system w/o conflicts |
| | Freedom from allergy conflicts |
| | Location (e.g. CVS on University Avenue) where drugs can be picked up |
| | Whether patient has insurance, how much co-pay is |
| | Summary of all drugs that the patient is currently on |
| | All of this is handled by a remote scribe. The above mentioned steps also work for |
| | other types of orders (e.g. tests, referrals). |
| Ordering via Voice | Doctor interfaces with portable hands free device such as Google glass, either |
| Recognition S/W | verbally (by saying a predetermined phrase such as “Augmedix order”) or by |
| | swipe and click interface with the display. |
| | Either a visual (e.g. popup or flash on display) or audio (e.g. chime sounding) |
| | confirms reception. |
| | Ordering process can be done via a combination of verbal and physical |
| | swipe/click interface. A limited vocabulary set including possible orders, tests, and |
| | medications can be used for voice recognition and NLP-enabled ordering. Each |
| | additional piece off data inputted (e.g. the name of the medication) automatically |
| | triggers display of the next decision point in the ordering process (e.g., oral vs. IV |
| | delivery route or available dosages) . . . |
| | The final order is sent to the EMR or other order processing system to be |
| | prescribed. |
| | Dashboard is displayed showing: |
| | Drug was committed to system w/o conflicts |
| | Freedom from allergy conflicts |
| | Location (e.g. CVS on downtown Palo Alto) where drugs can be picked up |
| | Whether patient has insurance, how much co-pay is |
| | Summary of all drugs that the patient is currently on |
| | All of this is handled by voice recognition software. The abovementioned steps |
| | also work for other types of orders (e.g. tests, referrals). |
| Freeform note- | Doctor interfaces with portable hands free device such as Google glass, either |
| taking via Remote | verbally (by saying a predetermined phrase such as “Augmedix take notes”) or by |
| Scribe (post-patient) | swipe and click interface with the display. |
| | Either a visual (e.g. popup or flash on display) or audio (e.g. chime sounding) |
| | confirms reception. |
| | Doctor indicates which patient he'd like to create notes for (default to last seen |
| | patient). |
| | Doctor begins free-form note dictation. |
| Freeform note- | Doctor interfaces with portable hands free device such as Google glass either |
| taking via Voice | verbally (by saying a predetermined phrase such as “Augmedix take notes”) or by |
| Recognition S/W | swipe and click interface with the display. |
| (post-patient) | Either a visual (e.g. popup or flash on display) or audio (e.g. chime sounding) |
| | confirms reception. |
| | a limited vocabulary including medical phrases can be used to increase quality of |
| | voice recognition. |
| | Doctor indicates which patient he'd like to create notes for (default to last seen |
| | patient). |
| | Doctor begins free-form note dictation. |
| | Made possible by hooking into Nuance API or alternative |
| | Optional: doctor sees note text creation, in real-time |
| | Optional: doctor has ability to use Dragon-style voice dictation commands |
| Concierge (EHR | Doctor interfaces with portable hands free device such as Google glass, either |
| Pull) via Remote | verbally (by saying a predetermined phrase such as “Augmedix query”) or by |
| Scribe | swipe and click interface with the display. |
| | Either a visual (e.g. popup or flash on display) or audio (e.g. chime sounding) |
| | confirms reception. |
| | Access of patient medical data can be done via a combination of verbal and |
| | physical swipe/click interface. |
| | Doctor says his request, e.g. “look up white blood cell count” |
| | result is either visually displayed or audibly conveyed via Glass |
| Concierge (EHR | Doctor interfaces with portable hands free device such as Google glass, either |
| Pull) via Voice | verbally (by saying a predetermined phrase such as “Augmedix query”) or by |
| Recognition S/W | swipe and click interface with the display. |
| | Either a visual (e.g. popup or flash on display) or audio (e.g. chime sounding) |
| | confirms reception. |
| | Accession of patient medical data can be done via a combination of verbal and |
| | physical swipe/click interface. |
| | limited vocabulary including medical vocabulary can be used to improve voice |
| | recognition accuracy |
| | Doctor says his request, e.g. “look up white blood cell count” |
| | result is either visually displayed or audibly conveyed via Glass |
| Messaging | Ability to send/receive text/voice/video messages with colleagues. Optionally taps |
| | into existing messaging system (e.g. Vocera). For an incoming message, shows: |
| | sender picture |
| | sender title |
| | priority level |
| | sender geo-location |
| | sender status |
| Alerts | The real time presentation of time-sensitive information to the physician via the |
| | Heads Up Display |
| | e.g. |
| | X lab or image is in |
| | X patient has arrived |
| | X service has left a consult note |
| | X patient is being brought down or being brought back from radiology |
| | Patient is undergoing/has finished physical therapy |
| | Patient's family has arrived/has a question. |
| Note review | Following completion of note by remote scribe or via voice recognition/NLP, note |
| | is sent to a workstation or to the physician headset for review. |
| | A core element to the process of note review is the ability to either automatically or |
| | on command highlight regions of increased concern, whether due to uncertainty or |
| | clinical significance. Such highlighting can occur either as a highlighting around or |
| | changing of font color of relevant section, as well as a display option in which the |
| | noncritical elements are made less visible, e.g. by graying them out or increasing |
| | font transparency. |
| | A further permutation of this highlighting is the ability to display only the region of |
| | concern, with some of the surrounding note to provide context. These high |
| | importance or high uncertainty areas of the chart can be sent individually to the |
| | physician's workstation or hands free display for review. |
| | Doctor should be able to “click confirm” to approve the record. Doctor should have |
| | the ability to send feedback regarding the quality of the note, through a free form |
| | or through selection of a value along a scale, e.g. a certain number of stars out of |
| | a maximum possible 5 stars. Doctor should able to review plan of action audio and |
| | send to patient, if applicable. |
| | This interface should be in sync with EHR via HL7 |
| Note review on | Doctors should be able to perform Note Revlew (see above) on a GUI optimized |
| Glass | for Glass |
| Transcript review | Some doctors will have minimal legal/patient privacy concerns. |
| | For these doctors, we want to store the entire audio/visual interview for later |
| | review. |
| | We'd like to provide doctors with the option to retrieve and view these past |
| | interviews. He needs to be able to search/filter to these past interviews using |
| | appropriate tags. |
| | While viewing these past interviews, we need to provide ability for him to RW, FF, |
| | pause, export. |
| | Ideally, we would apply the Nuance voice recognition API on top of these videos to |
| | make them index searchable (a Ia Gmail). Crude text transcripts should be made |
| | available. |
| Remote Scribe | Imports standardized templates |
| Entry Interface | Allows scribes to type into template forms |
| | Templates contain numerous drop-downs and auto-complete options |
| | Scribe can see audio/visuals from interview |
| | Scribe can see audio/visuals from post interview freeform notes |
| Remote Scribe | Imports standardized templates |
| Entry Interface | Allows scribes to type into template forms |
| Advanced | Templates contain numerous drop-downs and auto-complete options |
| | Scribe can see audio/visuals from interview |
| | Scribe can see audio/visuals from post interview freeform notes |
| | Scribe can use keyboard or foot-pedals to rewind/fast forward/speed up play- |
| | back |
| | Scribe can use keyboard or foot-pedals to change color of text, indicate high/low |
| | confidence, etc. |
| Remote Scribe | Allows remote scribe to see overall productivity metrics (vs. self and vs. other |
| Review Interface | scribes). |
| (part of integrated | Allows remote scribe to see individual before-and-after views of individual records |
| Remote Scribe | (before the doc edited and after the doc edited). |
| interface) | |
| Remote Scribe | Allows call center manager to review and manage supply, demand, outages, |
| Manager Dashboard | routing, etc. |
| | Allows for auditing. |
| | Allows for performance review comparisons. |
| | Allows manager to initiate and terminate permissions, view/edit schedules, etc. |
| Remote Scribe | Provides scribe with entire patient EHR record (but not data for other patients) |
| Query Interface | Keyboard shortcuts to navigate EHR record quickly, copy, paste, snippets into |
| (part of integrated | window, to be sent to Google Glass |
| Remote Scribe | Free-form text messages can also be sent to doctor as well |
| interface) | |
| Remote Scribe | Allows for assisting scribe to hear verbal orders for doctors. Allows for scribe to |
| Order Interface (part | select dropdowns, tree selection options, etc. to submit orders. These tree |
| of integrated | selections etc. should be visualized on the Glass display as well. |
| Remote Scribe | |
| interface) | |
| Technical warning | If battery is low and/or if connectivity is poor and/or if the call center is down, the |
| alerts | doc is alerted with an icon |
| “strike that” feature | Doc has ability to click button or gesture - which informs Scribe to not record or |
| | work on the last 15 seconds of activity. |
| | If the doc clicks again, this increases to the past 30 seconds. Then 45 seconds . . . |
| | and so on . . . visual indicators are present to indicate this |
| | These numbers will change based on doctor preference. |
| Consult | Doc or user has ability to transmit the audiovisual stream from his headset to |
| | another medical expert located elsewhere in the world. This remote expert can |
| | then be a part of the encounter for the purposes of training or consultation. The |
| | remote expert can see and hear what's going on in the room and contribute back |
| | via voice communications, text, or other means of communication. |
| | From a technical perspective, this is much like the aforementioned Scribe and |
| | Concierge features, but instead of remote scribes on the other end of the line, |
| | remote medical experts (e.g. on call cardiologists or dermatologist) are used. |
| | A particularly helpful use case of this would be a primary care doctor (PCP) |
| | located in a rural setting. There are very few specialists in rural America. By using |
| | the consult feature, a rural PCP can immediately get the input of hard-to-reach |
| | specialists throughout the country. |
| Monitor | Oftentimes, patients in a healthcare setting are hooked up to a variety of sensor- |
| | containing monitoring equipment. These sensors are constantly reading vitals |
| | such as blood oxygenation, heart rate, blood pressure, etc. Increasingly, these |
| | sensors and equipment are “wired”; they have network access and area often |
| | accessible to doctors located anywhere. |
| | With the Monitor feature, Augmedix users can view sensor data. Augmedix |
| | Monitor will provide the appropriate IP lookup and user-interfaces to make this |
| | seamless. |
| | This feature is particularly useful in an inpatient setting. |
| Educate | Doc or user has ability to transmit the audiovisual stream (or after-the-fact archive |
| | of stream) from his headset to another individual for the purposes of training or |
| | consultation. In the case of training, the audiovisual stream provides the trainee |
| | with the first person perspective of what the physician is doing, such as in the case |
| | of surgery or the physical exam. |
| Workflow guidance | Oftentimes, doctors and other busy medical professionals have a difficult time |
| | managing their minute-by-minute workflows and priorities. Imagine a rounding |
| | inpatient doctor or roving nurse, overseeing dozens of patients. Some patients are |
| | becoming critical, some are just entering the system, some are leaving the system, |
| | some had test results that just arrived, some are located nearby, and some are |
| | located far away. It's almost impossible to figure out what to do next. With |
| | Augmedix Workflow Guidance, interfaces are shown that help the medical |
| | professional know what to do next. The Workflow Guidance interface will elevate |
| | important information to the user's visual stream (e.g. Patient X is now in critical |
| | condition, your next action should be Y (right around the corner)). Workflow |
| | Guidance not only priories items and next steps by criticality, the feature also |
| | accounts for the user's spatial location next and other nearby staff members. For |
| | example, Workflow Guidance might preferentially guide a doctor to see a critical |
| | patient right around the corner specifically because the critical patient is so close |
| | and the nearest on-call doctor is a 10-minute walk away. |
| | All of this is made possible by: |
| | Creating an algorithmic rules engine that prioritizes what is shown to the |
| | user and under what circumstances |
| | Creating an interfaces to visually display Work Flow guidance |
| | Integration of spatial location information into the rules engine (made |
| | possible by Wi-Fi triangulation, Bluetooth triangulation, and/or other |
| | techniques) |
| | Integration real-time medical record data from the EHR (made possible by |
| | tapping into EHR APIs and/or HL7) |
| Language Agent | The conversation between the physician and a patient speaking a different |
| | language is facilitated by the sending of audio or audiovisual data from the Glass |
| | to another device or human translator that translates the conversation in near-real |
| | time, being displayed as text or as spoken or automatically generated audio in the |
| | other individual's display. |
| Patient Consent | Obtaining consent from a patient for medical care such as hospitalization, blood |
| Agent | transfusion, or surgery in the absence or in augmentation of an electronic or paper |
| | form can be accomplished by saving, either within or outside of the EMR, the |
| | audiovisual recording of the discussion and agreement between the physician and |
| | patient regarding the full description, risks, and benefits of the medical care |
| | requiring consent. |
| | Beyond patient consent, archived multimedia capture by Augmedix can be used |
| | for a variety of legal protection use cases. |
| Guidance - | Physician knowledge can be augmented by the real time or near real time access |
| Checklisting | of online resources, including but not limited to diagnostic or treatment algorithms, |
| | device documentation, medication side effects, disease characteristics, or other |
| | relevant medical information not otherwise immediately accessible to the |
| | physician. Such resources can be displayed to the physician in a way that allows |
| | for confirmation that all parts of the data being displayed are addressed. e.g.: A |
| | physician is able to pull up the recommended treatment guidelines for a |
| | myocardial infarction. Furthermore, the displayed data can change in response to |
| | physician input (e.g. voice action), or events occurring around the physician, such |
| | as physical exam findings or patient responses to questions asked. An example |
| | would be, in the above example, the ability to confirm or deny that certain |
| | elements of the recommended treatment guidelines have been completed, either |
| | manually by audio or physical entry or automatically by audiovisual interpretation |
| | by a third party. The display can also change in a matter that corresponds with a |
| | predetermined algorithm or guideline, with an example being the display changing |
| | when additional data is provided, either manually through a care provider or |
| | automatically through the EMR. An example would be treatment recommendations |
| | for myocardial infarction being provided on Glass changing when the results of an |
| | EKG read showing ST-elevation are uploaded. |
| Automation of Billing | As medical billing and coding are dictated by preexisting rules and conventions |
| and Coding | involving various elements of the patient encounter, the audiovisual stream from |
| | Glass in the course of a patient encounter (including any work done by the |
| | physician prior and after the encounter) can be inputted, either in its existing form |
| | or following interpretation by a human or voice recognition/natural language |
| | processing algorithm, into a form that evaluates the audiovisual content of the |
| | patient visit for appropriate level of billing and diagnoses. Such evaluations can be |
| | based upon complexity of the patient visit, services performed including history |
| | taking, physician examination, interpretation of test results, or prescription of |
| | medications, time spent in the encounter, or any other metrics used currently by |
| | either physicians or payers to determine appropriate level of billing. |
| Guidance - Billing | In addition to the automation of billing and coding through interpretation of the |
| and Coding | audiovisual stream, real time evaluation of the criteria involved in meeting a certain |
| | level of billing and the degree of completion of those criteria by the care provider |
| | can be used to provide feedback regarding necessary additional tasks to be |
| | performed to meet a given level of billing or coding. |
| | An example would be in the case of a physician who has not evaluated an |
| | adequate number of organ systems on his physical exam to qualify for a desired |
| | level of billing for an office visit. The display would alert the physician as to the |
| | discrepancy with the potential of either reducing the level of billing or of performing |
| | additional elements of the physical exam in order to meet the higher level of billing. |
| Face detection | Glass wearer is informed of names and other vital information for other team |
| | members that might be in his field of vision. This could be helpful when a doctor is |
| | working in a stressful environment, with a large team, with people he's never |
| | worked with before (whose names he cannot remember). |
| | This could be made possible with facial recognition technology. It could also be |
| | made possible with other geo-location technologies associated with electronics |
| | and/or badges that others might be wearing. |
| Expression Agent | Glass wearer is informed when the patient under examination displays agitation, |
| | evasion, etc. |
| Surgeon Note | Surgeon is able dictate-to-note, during surgery. For example, as a surgeon is |
| Record | making a particular type of incision in particular location, he can verbally dictate |
| | this information rather than having to remember and type later. This information is |
| | time-stamped (which makes it possible to line up notes with video-feeds from |
| | scopes, etc.). In addition, if the surgeon desires, pictures and videos can be |
| | recorded as part of the note. |
| Patient Lookup on | Scans license plate, IDs, credit cards . . . tries to look up patient record on the field |
| the field | |
| Family dial-in | Allows Glass wearer to dial up patient family members (or other trusted persons) |
| | to listen in and be a part of the interview. Numerous video/audio-conference |
| | technologies could be used. |
| Tool-tracker for | Increasingly, medical devices and tools have electronics in them. Thus, relative to |
| surgeons | Google Glass, it's possible to locate these tools in 3D space. This permits various |
| | features that Augmedix would like to offer. For example: |
| | If a tool or device was left inside of a patient (accidentally), this could trigger alerts |
| | and visuals informing the doctor of this critical issue. |
| | If a variety of tools are being used in a complex situation, visual guidance queues |
| | could display to help the doctor proceed with ease. |
| | Note: it's possible that, even tools and devices without embedded electronics |
| | could be accounted for in such scenarios. This could be made possible with |
| | advanced imaging/object recognition. |
| IFU lookup for | Oftentimes, medical devices and procedures require the use of complicated IFUs |
| surgeons | (instructions for use). These are often dense and static. Moreover, they aren't |
| | always on hand. We want to enable dynamic and visual IFUs to be displayed, on |
| | Glass, as needed. In addition, we want to make these IFUs easily summoned |
| | (through voice recognition, auto-detection of nearby objects, etc.). |
| Analyze (Medical | The data contained within the audiovisual recording of the physician patient |
| Brain) | conversation and the transcription of the conversation can be stored for |
| | subsequent analysis, including evaluation of outcomes, patient satisfaction, billing/ |
| | coding/reimbursement, or market research for healthcare related in |
| | pharmaceuticals or medical devices. Furthermore, these data can be applied, |
| | possibly with additional patient information provided by the EMR or by the |
| | physician, to guide physicians or other healthcare providers via the creation of |
| | CDSS or best practices. An example would be the en masse analysis of many |
| | patient encounters of abdominal pain and subsequent outcomes to determine the |
| | highest yield line of questioning. Another example would be the provision of |
| | patient perception of a pharmaceutical, along with verbatim quotes regarding its |
| | side effects, to the pharmaceutical's manufacturer. |
| Therapy Guidance | In future generations of Augmedix we want to provide visual cues that would help |
| | guide the surgeon/doctor during surgical therapies and complex procedures. The |
| | availability of real time audiovisual feedback to the healthcare provider enables |
| | physician guidance of actions performed. For example: we'd like to help visually |
| | guide a surgeon on where to make an incision (e.g. where a supposed tumor ends |
| | and begins). This guidance could take the form of graphical markers and audio |
| | cues. |
| | We expect that this feature will make heavy use of immersive future-gen HUD AR |
| | technologies, object recognition, and the like. |
| Gesture Measure | This is a specific type of gestural interface to assist surgeons. Here are some |
| for Surgeons | illustrative examples for how this feature works: |
| | Say a doctor wants to measure the length of a lesion. He could state something |
| | like “begin measure”, and he could point to the beginning of a lesion, and he then |
| | could state “end measure” and then point to the end point of a lesion. Glass would |
| | then display the length of the lesion in centimeters. |
| | Say a doctor wants to measure an annulus to determine the appropriate size for |
| | an artificial heart valve to be inserted. Perhaps he could maneuver his fingers |
| | around, to explore the space in 3D, and Glass would display the appropriate |
| | dimensions to guide the appropriate device geometry. |
| | These examples could be made possible with 3D cameras; 2D cameras |
| | augmented with software, or instrumented gloves. |
| Word for word | There are some situations (e.g. psychiatry) where the user will want a word-for- |
| transcription - | transcription. Glass wearer should be able to initiate and terminate this mode. |
| software | |
| Word for word | There are some situations (e.g. psychiatry) where the user will want a word-for- |
| transcription - by | transcription. Glass wearer should be able to initiate and terminate this mode. |
| humans | |
| BYOS - Bring your | Some healthcare groups will want to use software and hardware, but will want to |
| own scribe | provide their own scribes (based on site, based in the US, or based OUS). We |
| | want to allow for that. |
| Cache | In order to enable faster access to certain commonly used data within the patient |
| | record, these commonly used values can be accessed, either manually by a |
| | human or automatically via either direct access into the EMR database or through |
| | a standard interface such as HL7, and stored on a local server before the patient |
| | encounter. Subsequently, these values can be provided to the physician without |
| | requiring additional access of the EMR. An example would be for the most recent |
| | laboratory results to be previously pulled so that when the physician requests them |
| | there is minimal delay between the request and the subsequent display of |
| | information. |
| Location-based Sign | There are numerous workstations that doctors often encounter in a healthcare |
| On | environment. When a doctor approaches a workstation, wearing a logged on |
| | version of Glass, we want the nearby workstation to auto-login (perhaps with some |
| | minor additional authentication). In addition, mere proximity might trigger a nearby |
| | workstation to start pulling (caching) information that's likely to be queried by a |
| | physician (this saves time). |
| | Proximity sensing could be made possible through Bluetooth triangulation, Wi- |
| | Fi_33 triangulation, and/or other location techniques. |
| Offline Mode' | If the power goes out or if the internet goes out, audio-video capture from Glass |
| | will be stored locally and synced when available. Appropriate controls and |
| | notifications will then be offered to the Glass wearer. |
| Battery Optimizers | If Bluetooth-based internet connectivity is available. Glass automatically switches |
| | from Wi-Fi to Bluetooth, without service interruption. Similar optimizations should |
| | be made with among Wi-Fi, Bluetooth, and Cellular radios. |
| | Device sensors (e.g. microphones, gyros, HUD, cameras) are turned off base on |
| | various conditions to save battery. |
| Field Guidance | The ability for emergency first responders or other less-trained individuals to |
| | access guidance on Glass that is displayed through audio and/or visual feedback |
| | (e.g. timing of CPR), with or without the remote support of a higher trained |
| | individual. |
| Oversight | The ability to access the audiovisual feed on Glass to monitor, audit, assist, and/or |
| | train lower lever person(s) by providing audiovisual feedback, either in real time or |
| | delayed. |
| Gesture | Ability for Glass to detect the 3D position of the wearer's hands (and fingers). This |
| | allows for gestural interaction with the software. For example: the wearer could |
| | swipe in mid-air to close a window. Or a mid-air pinch-to-zoom exercise could |
| | allow the wearer to zoom into a menu or graphic that's being displayed on Glass. |
| | This could be made possible with 3D cameras, 2D cameras with software that |
| | interprets 3D positions, instrumented gloves, etc. |
| AV Censoring | Ability for Glass to censor faces and or sensitive anatomy in video feeds that might |
| | be archived or seen by scribes. This could be through the use of black boxes, |
| | blurring, etc. |
| Eye-tracking/ | Ability for Glass user to interact with software by looking at menus and physical |
| cursor/menu | objects (rather than relying upon voice dictation, touch, etc.) |
| interaction | |
| Review Markers | Ability for glass user to interact with the device during the point of care and |
| | indicate time points of interest. For example, if a doctor is having a conversation |
| | with a patient, and most of the discussion was chit chat, but the patient briefly |
| | revealed some disturbing symptoms, perhaps the doctor would tap Glass at that |
| | time. Then, at a later point in time, when the doctor is performing a review of the |
| | archived video, the video would be somehow time-marked when the patient was |
| | mentioning the disturbing symptoms. |
| Interface Elements | |
| Pending action bar | Upon initiation of a query, a countdown appears that provides the estimated time |
| | to completion of the query. |
| Stacking queries | Upon initiation of a query, the question appears in text, perhaps with relevant |
| | iconography. It hovers for a second or two. It then shrinks and moves to the top- |
| | right of the field of vision. If a second query is made, it is displayed, it then shrinks, |
| | it then moves to the top-right, just below where the prior query was placed. And so |
| | on . . . |
| Shrinking queries | Let's say a query (e.g. White Blood Cell Count) takes on average 5 seconds to be |
| | handled. We want the query sitting in the stack to shrink; at a constant rate, for 5 |
| | seconds, helping the Glass wearer get an intuitive feel for how long it's likely to |
| | take for the query to be handled. When the answer is ready, the stacked query |
| | disappears and the “answer” displays and hovers for a few seconds. Note: instead |
| | of shrinking, other techniques could be used (e.g. color change). |
| Hovering names | Name and picture bubbles show above people (pt., team members, etc.) in the |
| over people | field of vision. Medical record number etc. might also be displayed |
| Swipe away gesture | Glass wearer is able to “banish” a particular screen element by swiping away in |
| | mid-air or against the side of the Glass rim |

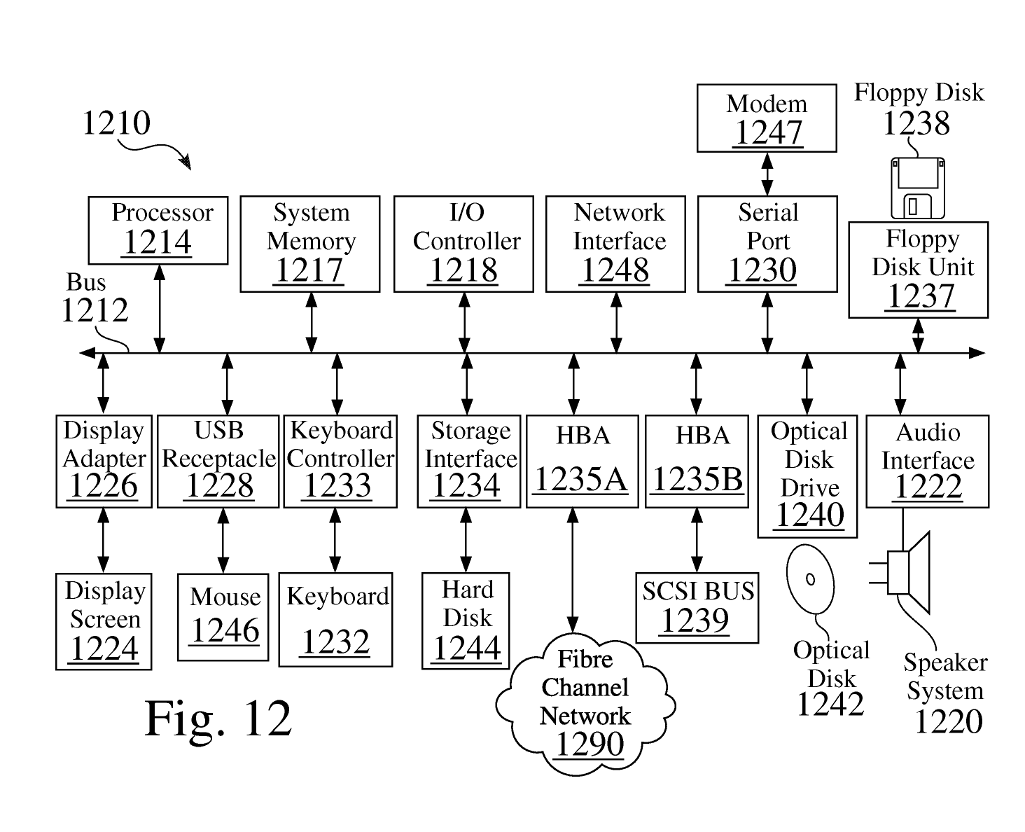

FIG. 12 provides a block diagram of a computer system 1210 suitable for implementing a system for augmenting healthcare-provider performance. Both clients and servers can be implemented in the form of such computer systems 1210. As illustrated, one component of the computer system 1210 is a bus 1212. The bus 1212 communicatively couples other components of the computer system 1210, such as at least one processor 1214, system memory 1217 (e.g., random access memory (RAM), read-only memory (ROM), flash memory), an input/output (I/O) controller 1218, an audio output interface 1222 communicatively coupled to an external audio device such as a speaker system 1220, a display adapter 1226 communicatively coupled to an external video output device such as a display screen 1224, one or more interfaces such as serial ports 1230, Universal Serial Bus (USB) receptacles 1230, parallel ports (not illustrated), etc., a keyboard controller 1233 communicatively coupled to a keyboard 1332, a storage interface 1234 communicatively coupled to at least one hard disk 1244 (or other form(s) of magnetic media), a floppy disk drive 1237 configured to receive a floppy disk 1238, a host bus adapter (HBA) interface card 1235A configured to connect with a Fiber Channel (FC) network 1290, an HBA interface card 1235B configured to connect to a SCSI bus 1239, an optical disk drive 1240 configured to receive an optical disk 1242, a mouse 1246 (or other pointing device) coupled to the bus 1212 e.g., via a USB (universal serial bus) receptacle 1228, a modem 1247 coupled to bus 1212, e.g., via a serial port 1230, and a network interface 1248 coupled, e.g., directly to bus 1212. Other components (not illustrated) may be connected in a similar manner (e.g., document scanners, digital cameras, printers, etc.). Conversely, all of the components illustrated in FIG. 12 need not be present.

The bus 1212 allows data communication between the processor 1214 and system memory 1217, which, as noted above may include ROM and/or flash memory as well as RAM. The RAM is typically the main memory into which the operating system and application programs are loaded. The ROM and/or flash memory can contain, among other code, the Basic Input-Output system (BIOS) which controls certain basic hardware operations. Application programs can be stored on a local computer readable medium (e.g., hard disk 1244, optical disk 1242) and loaded into system memory 1217 and executed by the processor 1214. Application programs can also be loaded into system memory 1217 from a remote location (i.e., a remotely located computer system 1210), for example via the network interface 1248 or modem 1247).

The storage interface 1234 is coupled to one or more hard disks 1244 (and/or other standard storage media). The hard disk(s) 1244 may be a part of computer system 1210, or may be physically separate and accessed through other interface systems.

The network interface 1248 and or modem 1247 can be directly or indirectly communicatively coupled to a network such as the Internet. Such coupling can be wired or wireless.

In an embodiment, the various procedure, processes, interactions and such take the form of a computer-implemented process.

In an embodiment, a program including computer-readable instructions for the above method is written to a non-transitory computer-readable storage medium, thus taking the form of a computer program product.

As will be understood by those familiar with the art, the invention may be embodied in other specific forms without departing from the spirit or essential characteristics thereof. Likewise, the particular naming and division of the portions, modules, components, features, attributes, methodologies and other aspects are not mandatory or significant, and the mechanisms that implement the invention or its features may have different names, divisions and/or formats. The foregoing description, for purpose of explanation, has been described with reference to specific embodiments. However, the illustrative discussions above are not intended to be exhaustive or limiting to the precise forms disclosed. Many modifications and variations are possible in view of the above teachings. The embodiments were chosen and described in order to best explain relevant principles and their practical applications, to thereby enable others skilled in the art to best utilize various embodiments with or without various modifications as may be suited to the particular use contemplated.

1. A system for augmenting performance of a healthcare provider during a patient encounter comprising:
at least one head-mounted client device wearable by said healthcare provider;
at least one remote site communicatively coupled to said head-mounted client device wearable by said healthcare provider; and
a provider interface integrated with said head-mounted client device wearable by said healthcare provider, said provider interface comprising at least one element for accepting patient-related data captured during and as a result of said patient encounter for transmission to said remote site, at least one element for transmitting the captured patient data and at least one element for presenting patient-related data transmitted from said remote site.

2. The system of claim 1, wherein said at least one head-mounted client device comprises one of:
at least one headset;
at least one gestural interface; and
at least one augmented reality contact lens.

3. The system of claim 2, wherein said provider interface comprises one or more of:
at least one microphone for capturing audio input during said patient encounter;
at least one video camera for capturing video input during said patient encounter;
at least one display apparatus for presenting visual data received from said remote site;
at least one headset for delivering audio data transmitted from said remote site; and
at least one geo-location determiner.

4. The system of claim 2, wherein said provider interface comprises a graphical user interface upon which video and textual data received from said remote site are presented to said provider.

5. The system of claim 1, wherein said remote site comprises at least one of:
a scribe cockpit manned by a human scribe, wherein the human scribe, responsive to transmission of patient encounter data, manipulates at least a portion of the transmitted patient encounter data for inclusion in an electronic health record (EHR) for the patient;
a scribe station attended by a virtual scribe, the virtual scribe comprising a computing device programmed for manipulating at least a portion of the transmitted patient encounter data for inclusion in the EHR; and
a computing device used by a third party for communicating with the provider

6. The system of claim 1, further comprising at least one provider workstation for reviewing and confirming data entered into an electronic health record for the patient by an operator at said remote site responsive to receipt of data acquired during or as a result of the patient encounter and transmitted to said remote site by the provider.

7. The system of claim 1, further comprising at least one remote computing device programmed for managing EHRs for a plurality of patients and for storing data contained in said EHRs.

8. The system of claim 1, further comprising a system management interface, said system management interface comprising means for performing any of:
review and management of any of supply, demand, outages, routing, auditing, performance reviews, permission granting, permission removal and scheduling; and
auditing ongoing communications providers and scribes, in real time and via archived media.

9. The system of claim 1, wherein the patient-related data transmitted to the remote site comprises one of:
information obtained by said provider as a result of examining and interviewing the patient and dictated by the provider in real time;
ambient audio information recorded during the interview;
video data recorded during the interview; and
data entered by the provider or by at least one member of a provider support team on a computer physically located within the said providers workplace.

10. The system of claim 1, wherein the patient-related data transmitted to the remote site comprises a request by the provider that the remote site provide specified information from an EHR for the patient and wherein the patient-related data transmitted from the remote site comprises data provided in response to the request.

11. The system of claim 1, wherein the patient-related data transmitted to the remote site comprises at least one request for:
at least one test, wherein said at least one test includes any of at least one laboratory analysis, at least one imaging test and at least one point-of-care test
at least one follow-up appointment; and
at least one referral to at least one additional provider;
wherein the patient-related data transmitted from the remote site comprises confirmation of the at least one request.

12. The system of claim 1, wherein the patient-related data transmitted to the remote site comprises at least one prescription for at least one medication and wherein the patient-related data transmitted from the remote site comprises confirmation of said prescription and a status report for said prescription.

13. The system of claim 1, wherein coupling between elements of said system is one of wired and wireless.

14. The system of claim 1, wherein one of multimedia data and sensor information are captured from a patient encounter and kept for later retrieval for at least one of:
reviewing details of one or more past cases to inform clinical decision-making;
reviewing details of one or more past cases to create large-scale statistics of past clinical decisions;
reviewing details of one or more past cases to determine appropriate billing, coding, and or reimbursement decision-making;
storing multimedia and sensor information for a predetermined time period for use as legal evidence that proper care was given;
storing multimedia and sensor information for a predetermined time period for use as legal evidence that patient consent was reasonably provided;
sharing at least part of the multimedia and sensor information with a patient, or non-providers designated by the patient;
sharing at least part of the multimedia and sensor information with a human or virtual transcriptionist for word-for-word transcription and storage as documentation;
sharing at least part of the multimedia and sensor information from one or more cases with any of medical device companies and pharmaceutical companies to better understand the way their products are discussed at the point of care;
sharing at least part of the multimedia and sensor information from one or more cases with any of medical students and other trainees who are learning about the practice of medicine;
reviewing details of past cases to inform clinical decision-making by means of an artificial intelligence algorithm having any of voice recognition and image or object recognition capabilities;
reviewing details of past cases to create large scale statistics of past clinical decisions by means of an artificial intelligence algorithm having any of voice recognition and image or object recognition capabilities; and
reviewing details of past cases to determine appropriate billing, coding, and reimbursement decision-making by means of an artificial intelligence algorithm having any of voice recognition and image or object recognition capabilities;
wherein said multimedia data includes at least one of mono-audio, multi-channel-audio, still images and video and wherein sensor information includes data from one or more of at least one accelerometer, gyroscope, compass, system clock, Bluetooth radio, Wi-Fi radio, Near-field communication radio, eye tracker sensor, air temperature sensor, body temperature sensor, air pressure sensor, skin hydration sensor, radiation exposure sensor, heart rate monitor, blood pressure sensor.

15. The system of claim 1, wherein said scribe cockpit allows for the selection and marking of elements of the transmitted patient encounter data for review by the provider in real time or at a later point in time.

16. The system of claim 1, wherein said patient-related data is selected and displayed based, at least in part, upon use of location-based patient identification via interaction of one of both of devices and wireless signals associated with the provider, patient, or patient room.

17. The system of claim 1, wherein the patient-related data transmitted to the remote site comprises a request by the provider that the remote site provide specified information from an EHR for the patient to at least one separate provider and wherein the patient-related data transmitted to the separate provider(s) from the remote site comprises data provided in response to the request.

18. A system for augmenting performance of a healthcare provider during a patient encounter comprising:
a head-mounted client device wearable by said healthcare provider;
a scribe station communicatively coupled to said head-mounted client device wearable by said healthcare provider; and
a user interface integrated with said head-mounted client device wearable by said healthcare provider, said user interface comprising at least one element for accepting patient-related data input by said healthcare provider for transmission to said scribe station and at least one element for presenting patient-related data transmitted from said scribe station in response to the transmission of the data to said scribe station.

19. A computer-implemented process for augmenting performance of a healthcare provider during a patient encounter comprising the steps of:
receiving patient-related data at a first computing device, the patient-related data transmitted from a second computing device communicatively coupled to said first computing device, said second computing device comprising a head-mounted computational device wearable by the healthcare provider, the patient-related data having been input by the healthcare provider via a user interface to the head-mounted computational device during or as a result of a patient encounter; and
responsive to receiving the patient-related data transmitted by said second computing device, transmitting patient-related data to said second computing device for presentation to said healthcare provider via said user interface to said head-mounted computational device.

20. The process of claim 19, wherein said remote site comprises at least one of:
a scribe cockpit manned by a human scribe, wherein the human scribe, responsive to transmission of patient encounter data, enters at least a portion of the transmitted patient encounter data into an electronic health record (EHR) for the patient;
a scribe station attended by a virtual scribe, the virtual scribe comprising a computing device programmed for entering at least a portion of the transmitted patient encounter data into the EHR; and
and at least one computing device for use by at least one third party for communicating with the provider.

21. The process of claim 19, wherein said at east one head-mounted client device comprises one of:
at least one headset;
at least one gestural interface; and
at least one augmented reality contact lens.

22. The process of claim 19, further comprising:
said first computer storing patient data in an EHR of the patient responsive to entry of said patient data by an operator of said computer, the patient data having been transmitted to the first computer by the provider responsive to acquisition during or as a result of the patient encounter; and at least one of:
the first computer transmitting the EHR, at least in part, to a provider workstation for review and confirmation by the provider; and
the first computer transmitting the EHR, at least in part, to at least one second provider workstation for review and provision of care by the at least one second provider.

23. The process of claim 19, further comprising one or more of:
the first computer receiving a request by the provider that the first computer provide specified information from an EHR for the patient;
the first computer, responsive to the request by the provider, transmitting the specified information from the EHR;
the first computer receiving at least one order for at least one test specified by the provider;
the first computer, responsive to the order, transmitting a confirmation of the order;
the first computer receiving a prescription for at least one medication ordered by the provider;
responsive to receiving the prescription, the first computer transmitting confirmation of said prescription and a status report for said prescription.

24. A computer program product for augmenting performance of a healthcare provider during a patient encounter comprising computer-readable instructions embodied on a non-transitory computer-readable medium, wherein execution of the computer-readable instructions programs a computational device for performing the steps of:
receiving patient-related data at a first computing device, the patient-related data transmitted from a second computing device communicatively coupled to said first computing device, said second computing device comprising a head-mounted computational device wearable by the healthcare provider, the patient-related data having been input by the healthcare provider via a user interface to the head-mounted computational device during or as a result of a patient encounter; and
responsive to receiving the patient-related data transmitted by said second computing device, transmitting patient-related data to said second computing device for presentation to said healthcare provider via said user interface to said head-mounted computational device.
